(19) United States
(12) Patent Application Publication
(10) Pub. No.: US 2023/0306508 A1
(43) Pub. Date: Sep. 28, 2023

(54) Computer-Implemented Method for Short-Term Energy Trading

(71) Applicant: Brady Energy UK Limited, Edinburgh (GB)

(72) Inventor: Chris REGAN, LONDON (GB)

(21) Appl. No.: 17/705,205

(22) Filed: Mar. 25, 2022

(51) Int. Cl. G06Q 40/04

(52) U.S. Cl. CPC G06Q 40/04

(57) ABSTRACT

A computer-implemented method for short-term energy trading is disclosed comprising: generating a position screen comprising an indication of a net open position between forecasted energy generation and forecasted energy sales in connection with a portfolio of assets, for one or more time periods; generating, in response to a user selection within the position screen, a trade screen for effecting a trade; the trade screen comprising trade order information and a place trade option; wherein the trade order information comprises a calculated volume to bring the net open position for a selected time period to zero, and a price for the trade of the calculated volume; and communicating, in response to a user selection of the place trade option, the trade order information to an exchange to execute the trade.

### FIELD OF DISCLOSURE

The disclosure relates to a computer-implemented method for short-term energy trading.

### BACKGROUND

As a consequence of de-carbonisation and de-centralisation, energy generation from traditional large-scale power plants is gradually being replaced by that from renewable and other energy sources such as solar and wind power.

Similarly, traditional energy trading, based on a long-term outlook, is being transformed and there is a move to short-term (intra-day) energy trading. However, to date, entering the short-term energy trading market has required significant investment in systems, knowledge and infrastructure to manage real-time physical delivery. Legacy systems designed for coal and gas power generation are simply unsuitable to provide the required response times and therefore a new system for effectively managing short-term energy trading, and the associated energy output, is required.

The present disclosure therefore seeks to overcome shortcomings of the prior art systems and/or provide a useful alternative.

### SUMMARY

One or more aspects of the present disclosure relate to a computer-implemented method for short-term energy trading in which a user (e.g. trader) may quickly execute a trade without having to operate more than one program application. Furthermore, the user is not required to enter details of the trade required because the system is configured to calculate an optimal trade, based on the trader's net open position; to automatically populate a trade order based on the trader's requirements and live market price information; and to execute the trade on an exchange, in response to the trader's confirmation. As such, intra-day trading can be performed with only minimal user interaction, thus facilitating quick and accurate trading.

In accordance with a first aspect of the disclosure there is provided a computer-implemented method for short-term energy trading, the method comprising;
generating a position screen comprising an indication of a net open position between forecasted energy generation and forecasted energy sales in connection with a portfolio of assets, for one or more time periods;
generating, in response to a user selection within the position screen, a trade screen for effecting a trade; the trade screen comprising trade order information and a place trade option; wherein the trade order information comprises a calculated volume to bring the net open position for a selected time period to zero, and a price for the trade of the calculated volume; and
communicating, in response to a user selection of the place trade option, the trade order information to an exchange to execute the trade.

Embodiments of the first aspect of the disclosure therefore relate to a method for quickly and easily placing a trade on an exchange without having to change programs or interfaces. All of the actions required for the trade can be carried out by the user from the initial position screen. Moreover, as the system calculates the volume required to being the net open position to zero and automatically populates the trade screen with the required volume and current market price, time is saved and accuracy increased. Accordingly, a trader may place a trade early, potentially before other traders, and this may be financially beneficial.

Traditionally, a trader would need to determine their position using one application, view the price on a separate exchange platform and then manually enter the volume and price required and place a bid (or aggress someone else's order) on the exchange by pressing a submit button. This process can be time consuming and due to the nature of Intra-day trading markets the prices may have changed by the time the trader is ready to execute a trade. The present disclosure therefore addresses these short-comings.

The method may further comprise calculating the volume to bring the net open position for a selected time period to zero.

The method may further comprise retrieving volume and price information from the exchange. The retrieval may be performed at regular intervals to ensure the information is updated to reflect current (or at least very recent) market values.

The portfolio may include one or more assets.

The method may further comprise obtaining the price from the exchange in real-time. For example, when the user selects to open the trade screen, an operation may be triggered to retrieve the current market price from the exchange and to display the current market price in the trade screen.

The trade screen may be editable such that a trader may edit the price or volume of the trade and the trade screen will update the volume or price of the trade, respectively, as a result of the edit.

The trade screen may further comprise data relating to one or more of: product information; market order depth; bid offer spread; closed orders. The data may be obtained from the exchange and/or from other applications.

The place trade option may be configured to place the trade as one or more of: an instantly executable trade; a limit order trade; a strip trade.

The method may further comprise refreshing the trade screen to reflect a change in the price in real-time. For example, updates in the price may be made as a result of a pull operation (i.e. following a request for an update) or a push operation (i.e. on receiving an update).

The position screen may provide the indication for multiple consecutive time periods.

The one or more time periods may each have a duration of one market settlement period. For example, in the UK, the local market settlement period is 30 minutes. However, in other countries this may vary.

The indication of the net open position may be provided in the form of a graph (e.g. of time period versus net open position). In which case, the user selection within the position screen may comprise a selection in the region of a time period of interest.

The indication of the net open position may be provided in the form of a table. In which case, the user selection within the position screen may comprise a selection of a cell containing an open position value.

The trade screen may be configured differently depending on whether the trade required to bring the net open position to zero relates to buying or selling.

At least an element of the trade screen may be coloured differently depending on whether the trade required to bring the net open position to zero relates to buying or selling. For example, the place trade option (e.g. button) may be coloured differently depending on whether the trade relates to a buy order or a sell order.

The trade may result in one of: an energy asset being turned on; an energy asset being turned up; an energy asset being turned off; or an energy asset being turned down. Thus, resulting in a change in the overall net open position of the trader.

The forecasted energy generation may take into account one or more of: asset capacity; renewables generation forecast; asset generation forecast; market price for energy generated; cost of generating energy.

The forecasted energy sales may take into account one or more of: time of day; time of week; time of year; renewables generation forecast.

The forecasted energy generation may be provided by one or more of: a battery; a wind turbine, a solar panel, a tidal generator or another energy source.

The method may further comprise generating an order confirmation when the trade has been executed.

The method may further comprise updating the position screen to reflect the trade once executed. For example, the net open position may be balanced.

The exchange may comprise more than one exchange and the price may be based on a combined bid offer stack.

In accordance with a second aspect of the disclosure there is provided a non-transitory computer readable medium comprising instructions for carrying out the method as described above.

These and other aspects will be apparent from the embodiments described in the following. The scope of the present disclosure is not intended to be limited by this summary nor to implementations that necessarily solve any or all of the disadvantages noted.

Any features described in relation to one aspect of the disclosure may be applied to any one or more other aspect of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Certain embodiments of the invention will now be described, by way of example only, with reference to the accompanying drawings, in which:

FIG. 1 shows a schematic representation of a trading system in accordance with an embodiment;

FIG. 2 shows a computer-implemented method for short-term energy trading in accordance with an embodiment;

FIG. 3A shows an example screenshot of a position screen showing net open position in the form of a graph in accordance with an embodiment;

FIG. 3B shows an enlarged portion of the screenshot of FIG. 3A, with an open position at period 6 highlighted, in accordance with an embodiment;

FIG. 3C shows a greater portion of the position screen of FIG. 3B, with a trade screen overlaid, in accordance with an embodiment;

FIG. 4 shows the trade screen of FIG. 3C in isolation;

FIG. 5 shows an order confirmation screen, in accordance with an embodiment;

FIG. 6 shows a view similar to that of FIG. 3B after the open position at period 6 has been balanced, in accordance with an embodiment;

FIG. 7 shows an example screenshot of a position screen showing net open position in the form of a table, with a trade screen overlaid and configured for a buy order, in accordance with an embodiment; and

FIG. 8 shows an example screenshot of a position screen showing net open position in the form of a table, with a trade screen overlaid and configured for a sell order, in accordance with an embodiment.

### DETAILED DESCRIPTION OF CERTAIN EMBODIMENTS

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents. In the following embodiments, like components/steps are labelled with like reference numerals.

In the following embodiments, the term memory is intended to encompass any computer readable storage medium and/or device (or collection of data storage mediums and/or devices). Examples of memories include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and the like.

As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as a memory or other type of storage device. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, microcontroller or other type of processing device or combination thereof.

Specific embodiments will now be described with reference to the drawings.

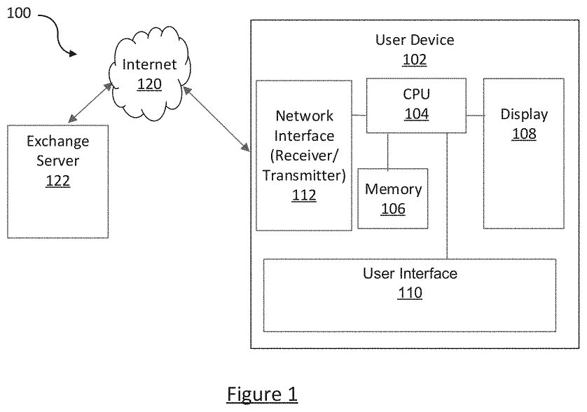

FIG. 1 illustrates a trading system 100 according to an embodiment of the invention. The system 100 comprises a user device 102, which may take the form of a personal computer (PC), laptop, tablet or the like. The user device 102 comprises a processor in the form of a central processing unit (CPU) 104, which is connected to a memory 106, a display 108, a user interface 110 and a network interface (receiver/transceiver) 112. The network interface 112 is configured to connect the user device (via a wired or wireless connection) to the internet 120. An exchange server 122 is also connected to the internet 120 and data and/or instructions may be transmitted in both directions between the user device 102 and the exchange server 122, via the internet 120.

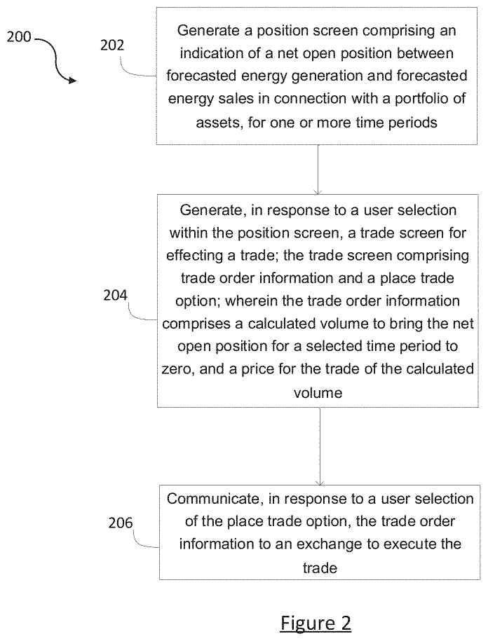

The memory 106 may comprise a non-transitory computer readable medium comprising instructions for carrying out the method of FIG. 2 as described below.

The display 108 may comprise a liquid crystal display, a light-emitting diode display or another display device.

In some embodiments, the user interface 110 may take the form of a touch screen and, in which, case, the user interface 110 may be integrated into the display 108. In other embodiments, the user interface 110 may comprise one or more of: a keyboard, a mouse, a tracker or a speech recognition device.

The network interface 112 may comprise a modem or cellular interface for connecting the user device 102 to the internet 120.

The exchange server 122 may comprise one or more processors and one or more memories for hosting the exchange. In practice, a plurality of user devices 102 will be connected to the exchange server 122 via the internet 120 to allow a plurality of users to trade on the exchange.

In some embodiments, one or more functions of the user device 102 may be carried out remotely. For example, one or more of the operations carried out by the CPU 104 and/or memory 106 may be performed via a cloud-based service, connected to the user device 102 via the network interface 112 and internet 120.

FIG. 2 shows a computer-implemented method 200 for short-term energy trading in accordance with an embodiment. The method 200 comprises a first step 202 of generating a position screen comprising an indication of a net open position between forecasted energy generation and forecasted energy sales in connection with a portfolio of assets, for one or more time periods. The method 200 also comprises a step 204 of generating, in response to a user selection within the position screen, a trade screen for effecting a trade; the trade screen comprising trade order information and a place trade option; wherein the trade order information comprises a calculated volume to bring the net open position for a selected time period to zero, and a price for the trade of the calculated volume. The method 200 further comprises step 206 of communicating, in response to a user selection of the place trade option, the trade order information to an exchange to execute the trade.

Accordingly, the method 200 allows the user to launch a trade order screen directly from their position overview screen (e.g. position reporting and trading functions are integrated in the present disclosure). Furthermore, much of the data needed to execute a trade order is pre-populated, thereby simplifying and expediting the trading process.

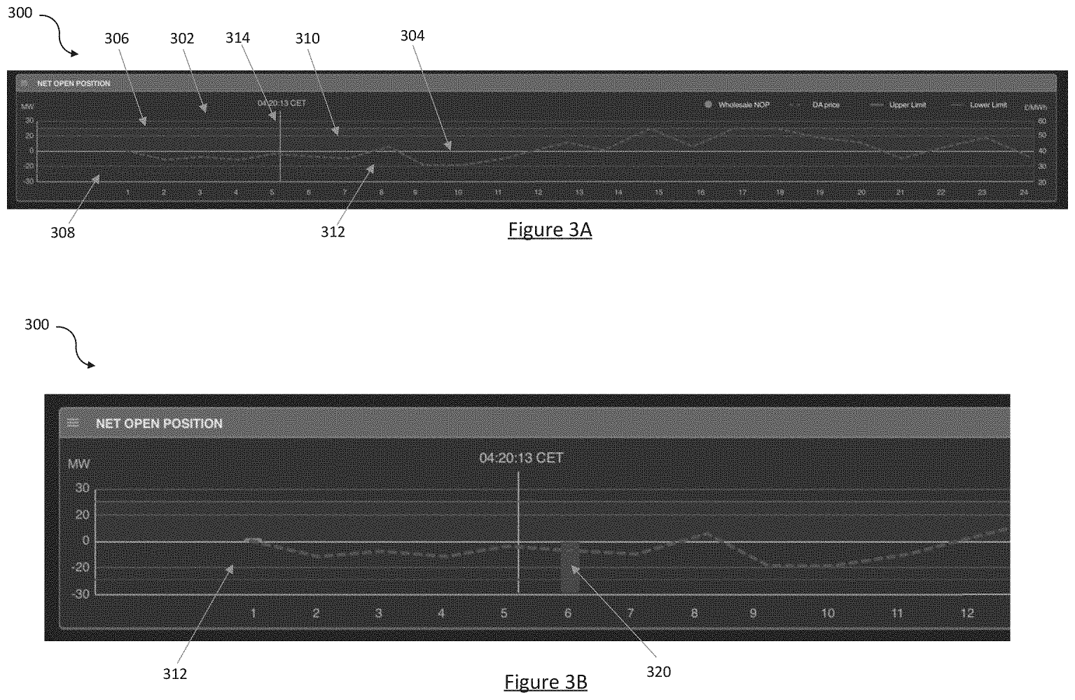

An example, of operation of the method 200 is described in more detail with respect to FIGS. 3A to 6.

FIG. 3A shows an example screenshot of a position screen 300 showing a user's net open position in the form of a graph 302 in accordance with an embodiment. As shown, the graph 302 comprises a horizontal x-axis denoting 24 consecutive time periods, a left vertical axis denoting energy volume in MW (from −30 to +30), and a right vertical axis denoting price per MW hour (£MWh) (from 20 to 60). A horizontal line 304 extending at 0 MW denotes a balanced net open position. An upper limit 306 is defined by a green horizontal line at +25 MW out of position and a lower limit 308 is defined by a red horizontal line at −25 MW out of position. An upper green zone is illustrated between the horizontal line 304 and the upper limit 306. A lower red zone 312 is illustrated between the horizontal line 304 and the lower limit 308. The green zone 310 indicates a long position and the red zone 312 indicates a short position. A vertical line 314 indicates the current time with respect to the horizontal x-axis. A day-ahead (DA) price is also plotted on the graph 302 against the right vertical axis (£MWh).

As shown clearly in FIG. 3B, an open position has appeared at period 6 and is highlighted by a bar 320 in the lower red zone 312. This indicates that the trader's net open position is short (i.e. they are have a volumetric shortfall) in period 6. This may occur, for example, when a new forecast is received indicating that the forecasted energy generation is going to be less than previously expected in that period. To address this situation, the user can simply click on the open position bar 320 to launch a trade screen 400, as shown in FIG. 3C. The trade screen 400 is provided in a pop-up box, which is overlaid on the position screen 300. Notably, the trade screen 400 is pre-populated with various data as will be explained in more detail below. In particular, the trade screen 400 comprises a calculated volume (Quantity) to bring the net open position for the selected time period to zero, and a price for the trade of the calculated volume. The user only needs to click on a place trade option 402 (which in this case, is a Place Buy option) to execute the trade indicated. Thus, the trade screen 400 replicates the functionality of placing an order directly on the exchange requiring minimal user interaction. More specifically, the above example requires only two mouse clicks to place an appropriate trade from the position screen 300 (e.g. first click on open position and second click to confirm trade).

Although the trade screen 400 is configured to be pre-populated with suitable trade information, if the user so wishes, some of the details in the trade screen 400 may be manually edited to allow greater flexibility for the trader. For example, the trader may choose to edit the volume price pair to place a limit order rather than an instantly executed trade.

Once the place trade option 402 has been selected, the system will forward the trade order information to the exchange server 122 to execute the trade on the exchange.

Although the example, illustrated in FIG. 3B relates to an out of balance position wherein the trader is short (i.e. the forecasted energy generation is lower than the forecasted (existing) energy sales in connection with the portfolio of assets for the period concerned), the example could equally relate to an out of balance position wherein the trader is long (i.e. the forecasted energy generation is greater than the forecasted (existing) energy sales in connection with the portfolio of assets for the period concerned). In either case, the method disclosed can be used to determine the volume required to buy or sell (and the price associated with said trade) to bring the net open position back into balance.

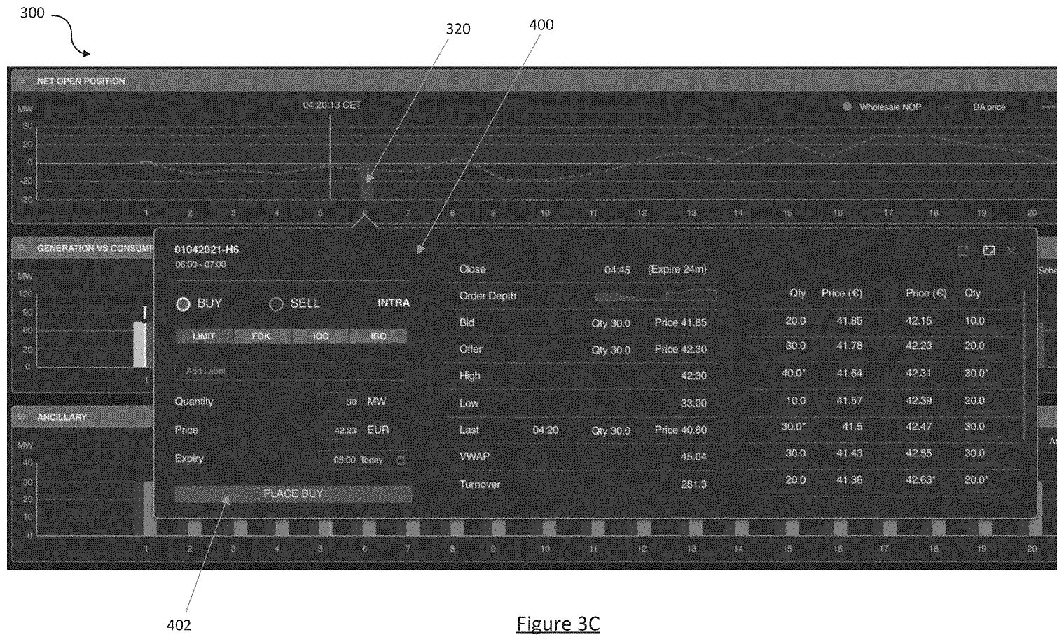

FIG. 4 shows the trade screen 400 of FIG. 3C in more detail.

As explained above, when the user selects an open position on the position screen 300, the system calculates the volume (quantity 404 of MW) to bring the net open position for the selected time period to zero and retrieves a price 406 for the trade of the calculated volume from live market data. In more detail, the CPU 104 requests live market data from the exchange server 122 and receives the live market data over the internet 120 via the network interface 112. The live market data may be automatically updated by the exchange server 122 such that any changes are received at the CPU 104 with a latency of less than 1 second.

The live market data may comprise a bid/offer stack for buying or selling a selected product (the product being that suitable for providing the energy required in the period concerned). The bid/offer stack may be shown on the trade screen 400 in table 420, which lists all of the available bids in price descending order and all of the available offers in price ascending order, such that the top row provides the most attractive numbers. The CPU 104 will use the bid/offer stack to determine a best bid/offer price 406 for the volume required to fill the order so as to immediately close out and balance the trader's net open position. For example, to buy the quantity 404 of 30 MW the price 406 must be as high as the second sell offer of £42.23 in the bid/offer stack 420. By bidding this price the trader would automatically buy the first offer of 10 MW at £42.15 and the second offer of 20 MW at £42.23, thus buying the required 30 MW in total.

If the data in the bid/offer stack changes (i.e. the live market data received from the exchange server 122 includes changes) while the trade screen 400 is open, the system will update the table and recalculate the price 406 for the quantity 404 required. However, if the user has manually edited the price 406, the system will not automatically update the price 406 until after the current trade screen 400 has been closed and a new trade screen 400 opened.

The quantity 404 (i.e. energy volume in MW) that is required to balance the net open position is pre-populated along with the determined price 406 (in £/MWh), when the trade screen 400 is initially opened. As such, the trade screen 400 will clearly show the trader the product they are going to trade along with an expiry time 408 for the product. In some embodiments, the expiry time 408 may be optional or may be set by default to match a time of gate closure for the selected product in the time period concerned.

The trade screen 400 may include an indication of whether the trade is to buy 410, sell 412 or is an intra-day trade 414. If the trade is to buy 410, the place trade option 402 will represent a buy order and at least the place trade option 402 button may be coloured to indicate a buy. Similarly, if the trade is to sell 412, the place trade option 402 will represent a sell order and at least the place trade option 402 button may be coloured to indicate a sell. For example, buy orders may be coloured purple and sell orders may be coloured green so that the trader is clear on the direction of the order being submitted.

The trade screen 400 may further provide the trader with the ability to choose which type of market order will be submitted by selecting a market order option 416. For example, the market order may be a limit order, may be a fill or kill (FOK) order, may include an intermediate-or-cancel (10C) order, an iceberg order (IBO) or may include other market order options. For example, traders may be permitted to execute a strip of prompt products.

As shown in FIG. 4, the trade screen 400 also contains a list of other information 418 including a close time, a live market order depth graphic, a summary of the bid/offer spread (e.g. taken from the top row of table 420), the historical highest and lowest bid prices for the product concerned, details (including time, quantity and price) of the last trade for the product, the volume-weighted price average (VWAP) figure for the product and the turnover for the product.

In some embodiments, the trade screen 400 may show a combined bid offer stack from two or more exchanges if the trader is a member of multiple exchanges. Thus, the trader will be provided with a comprehensive view of all prices and possible trades via a single user interface. However, if the trader is only a member of one exchange, the trade screen 400 will only show prices relevant to that exchange.

As explained above, if the trader is happy to proceed with the trade as pre-populated (or as edited), selecting the place trade option 402 will instruct the system to execute the trade on the relevant exchange. In which case, the CPU 104 will communicate the trade to the relevant exchange server 122.

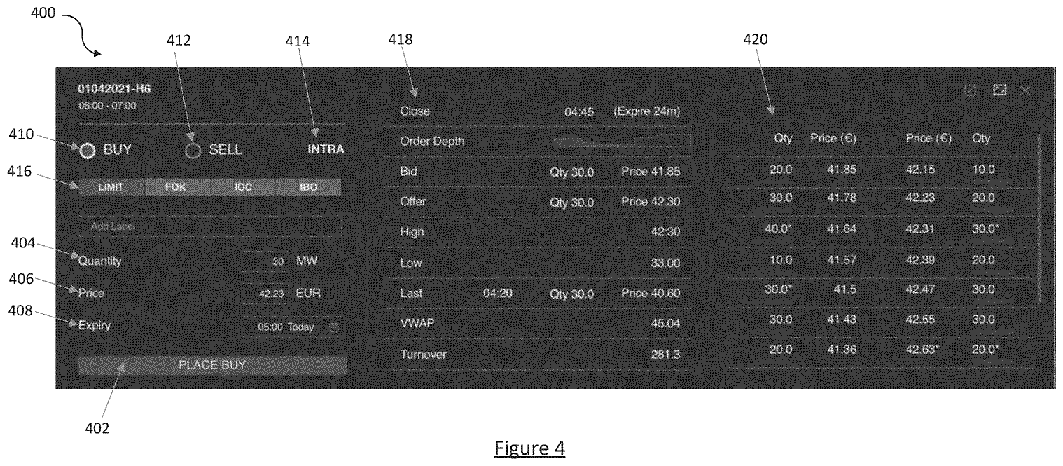

Once the trade order has been executed, the trade screen 400 will be replaced with a pop-up order confirmation screen 500 as shown in FIG. 5. The order confirmation screen 500 includes confirmation that the trade has been executed and, optionally, details of the trade order placed (including for example, the volume and price). The order confirmation screen 500 includes options for the user to select, which include an option 502 to view all trades and an option 504 to return to the position screen 300.

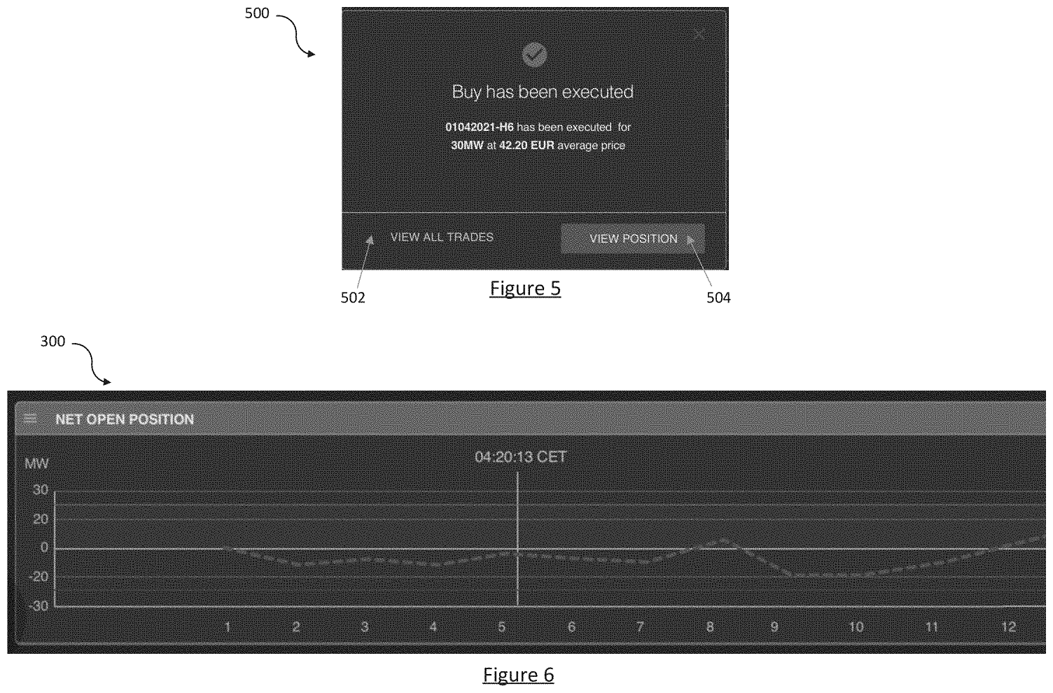

FIG. 6 shows a view similar to that of FIG. 3B after the open position at period 6 has been balanced. Thus, if the user selects the option 504 to return to the position screen 300, an updated position screen 300 is shown to reflect the change in net open position due to the trade. As shown in FIG. 6, this means that, in the present example, the open position bar 320 of FIG. 3B is no longer visible.

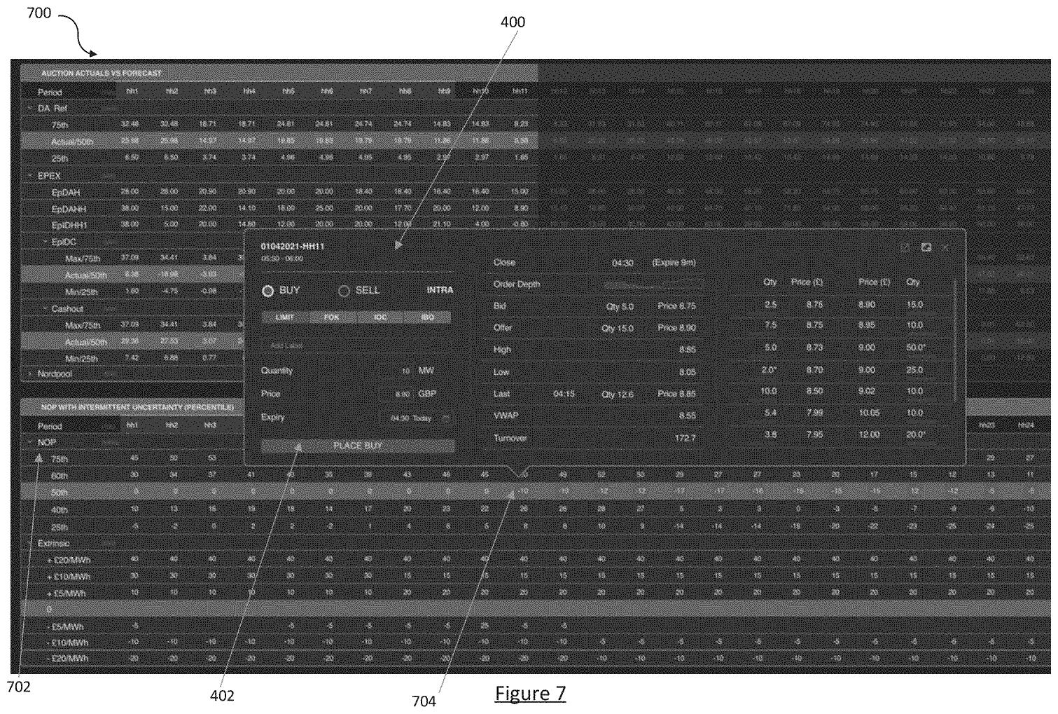

FIG. 7 shows an example screenshot of a position screen 700 showing net open position in the form of a table 702, with the trade screen 400 overlaid and configured for a buy order, in accordance with an embodiment. In this example, the trade screen 400 is launched by a user clicking on a cell 704 indicating an open position in the table 702 (in this case the position is short). The configuration and operation of the trade screen 400 is the same as described above and will not be repeated. In summary, the trade screen 400 will be pre-populated with the required volume and price to balance the trader's net open position such that the user may immediately select the place trade option 402 to place the required buy order (assuming they do not wish to manually intervene with the order details).

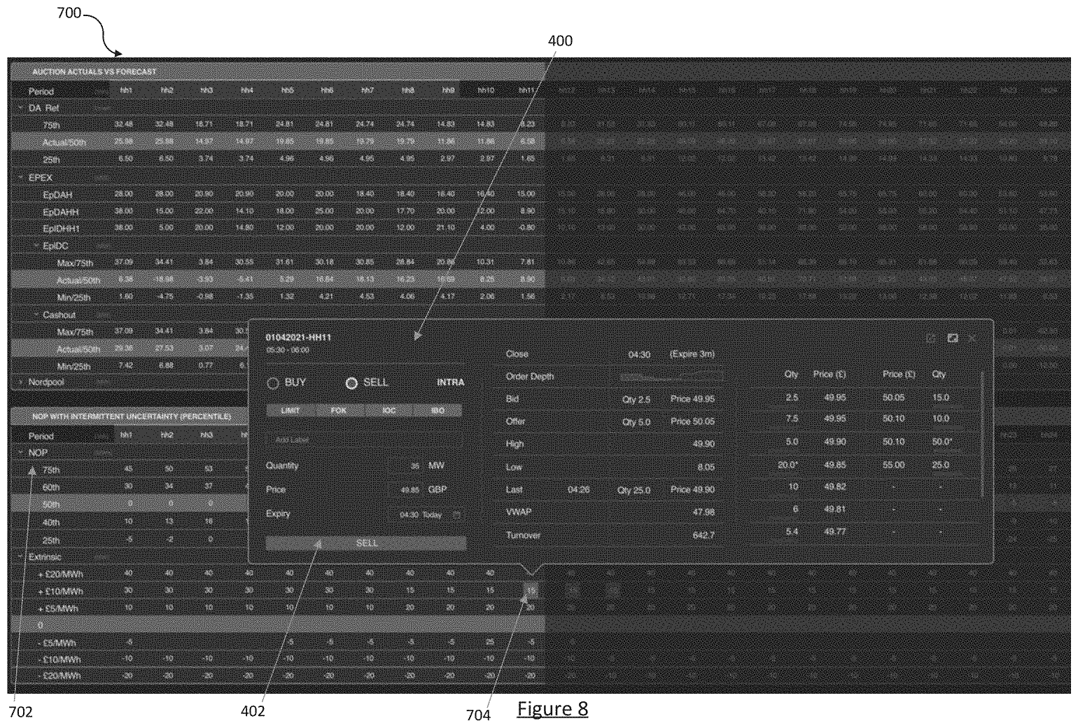

FIG. 8 shows an example screenshot of the position screen 700, with the trade screen 400 overlaid and configured for a sell order, in accordance with an embodiment. As for FIG. 7, the trade screen 400 is launched by a user clicking on a cell 704 indicating an open position in the table 702 (however, in this case the position is long). The configuration and operation of the trade screen 400 is the same as described above and will not be repeated. In summary, the trade screen 400 will be pre-populated with the required volume and price to balance the trader's net open position such that the user may immediately select the place trade option 402 to place the required sell order (assuming they do not wish to manually intervene with the order details).

In a further example, a trader may be balanced in the time period denoted Half Hour 11 (HH-11), i.e. they have sold their forecasted energy generation. The trader then receives a revised forecast that is 20 MW lower for energy generation in HH-11. As such, the trader is now short (i.e. they have a negative balance having sold more than they can generate) by 20 MW.

Previously the trader would have had to go to a separate exchange application and click on the HH-11 instrument to open an order box. The order screen would be prepopulated with offer or bid (depending on which wide was selected) prices and volumes. However, there would be no transfer of information from the position screen (i.e. position reporting software) to the exchange. Accordingly, the trader would need to enter the volume required (e.g. 20 MW) into the volume of the order box and adjust the price to cover 20 MW from the available bids in the market. The trader may look for orders with the position closed (all or nothing) and adjust their order manually to account for orders not accessible.

With embodiments of the present disclosure, the trader would need to simply click on their net open position on the position screen to launch the trade screen 400 (which is connected to the exchange but handled within the current position software). Furthermore, the volume to buy (or sell) will be extracted from the position screen 300 and pre-populated in the trade screen 400 and the price determined (based on current market and closed/open orders) to fill the required volumes to close the position.

Thus, the method of the present disclosure may provide a trader with a pop-up screen including pre-populated price and volume data enabling the trader to balance any long or short position without having to leave the position reporting software. Accordingly, accurate trades can be placed much faster than in the prior art.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Furthermore, features described in relation to one embodiment may be mixed and matched with features from one or more other embodiments, within the scope of the claims.

1. A computer-implemented method for short-term energy trading, the method comprising;
generating a position screen comprising an indication of a net open position between forecasted energy generation and forecasted energy sales in connection with a portfolio of assets, for one or more time periods;
generating, in response to a user selection within the position screen, a trade screen for effecting a trade; the trade screen comprising trade order information and a place trade option; wherein the trade order information comprises a calculated volume to bring the net open position for a selected time period to zero, and a price for the trade of the calculated volume; and
communicating, in response to a user selection of the place trade option, the trade order information to an exchange to execute the trade.

2. The method of claim 1 further comprising obtaining the price from the exchange in real-time.

3. The method of claim 1 wherein the trade screen is editable such that a user may edit the price or volume of the trade and the trade screen will update the price or volume of the trade, respectively, as a result of the edit.

4. The method of claim 1 wherein the trade screen further comprises data relating to one or more of: product information; market order depth; bid offer spread; closed orders.

5. The method of claim 1 wherein the place trade option is configured to place the trade as one or more of: an instantly executable trade; a limit order trade; a strip trade.

6. The method of claim 1 further comprising refreshing the trade screen to reflect a change in the price in real-time.

7. The method of claim 1 wherein the position screen provides the indication for multiple consecutive time periods.

8. The method of claim 1 wherein the one or more time periods each have a duration of one market settlement period.

9. The method of claim 1 wherein the indication of the net open position is provided in the form of a graph.

10. The method of claim 1 wherein the indication of the net open position is provided in the form of a table.

11. The method of claim 1 wherein the trade screen is configured differently depending on whether the trade required to bring the net open position to zero relates to buying or selling.

12. The method of claim 11 wherein at least an element of the trade screen is coloured differently depending on whether the trade required to bring the net open position to zero relates to buying or selling.

13. The method of claim 1 wherein the trade results in one of: an energy asset being turned on; an energy asset being turned up; an energy asset being turned off; or an energy asset being turned down.

14. The method of claim 1 wherein the forecasted energy generation takes into account one or more of: asset capacity; renewables generation forecast; asset generation forecast; market price for energy generated; cost of generating energy.

15. The method of claim 1 wherein the forecasted energy sales take into account one or more of: time of day; time of week; time of year; renewables generation forecast.

16. The method of claim 1 wherein the forecasted energy generation is provided by one or more of: a battery; a wind turbine, a solar panel, a tidal generator or another energy source.

17. The method of claim 1 further comprising generating an order confirmation when the trade has been executed.

18. The method of claim 1 further comprising updating the position screen to reflect the trade once executed.

19. The method of claim 1 wherein the exchange comprises more than one exchange and the price is based on a combined bid offer stack.

20. A non-transitory computer readable medium comprising instructions for carrying out the method according to claim 1.
